(19) United States
(12) Patent Application Publication
(10) Pub. No.: US 2024/0404353 A1
(43) Pub. Date: Dec. 5, 2024

(54) MACHINE VISION-BASED DETECTING AND PROCESSING OF TABLE GAME EVENTS

(71) Applicant: NRT TECHNOLOGIES, INC., Las Vegas, NV (US)

(72) Inventors: Michael Dominelli, Toronto (CA); Nasr Sattar, Las Vegas, NV (US); Reza Soltani, Toronto (CA); Deon Wood, Union, KY (US)

(21) Appl. No.: 18/733,017

(22) Filed: Jun. 4, 2024

Related U.S. Application Data
(60) Provisional application No. 63/506,140, filed on Jun. 5, 2023.

(51) Int. Cl. G07F 17/32; G06V 10/70; G06V 20/52; G06V 20/64

(52) U.S. Cl. CPC G07F 17/3239; G06V 10/70; G06V 20/52; G06V 20/64; G07F 17/322; G07F 17/3241

(57) ABSTRACT

Systems and methods are provided to capture and analyze events in a casino using approaches that efficiently manage computing resources. One or more cameras are positioned proximate to a gaming table. Image data from the cameras can be analyzed using machine learning models to understand the events occurring at the gaming table. A first machine learning model is maintained at an edge server that can be positioned within a gaming environment, for example. The machine learning model on the edge server can be a copy of machine learning model on a cloud-based server. Through ongoing testing and training activities, the machine learning model on the cloud-based server can be updated for the purposes of improving object detection accuracy. Once the machine learning model has been updated, such updates can be provided to the machine learning model on the edge server.

### CROSS-REFERENCE TO RELATED APPLICATIONS

The application claims the benefit of U.S. Ser. No. 63/506,140, filed on Jun. 5, 2023, entitled, “Machine Vision-Based Detecting and Processing of Table Game Events,” the disclosure of which is incorporated herein by reference its entirety.

### BACKGROUND

Playing casino table games is a widely enjoyed form of entertainment, but behind the scenes there are numerous intricate processes taking place in the realm of casino operations. These processes encompass various aspects of table games, including the meticulous counting of money at the table, the efficient distribution of chips to players, the vital task of rating players, as well as the documentation of relevant details when players choose to buy-in for significant sums without seeking a rating (pertinent to anti-money laundering (AML) monitoring). Moreover, the determination of the outcome of each round of play is an essential procedural element.

The rating of players serves a crucial purpose by allowing the casino to assess the value of each player and the potential revenue their gameplay generates. Casinos strive to retain players with favorable ratings, as it enables them to offer complimentary goods or services as a gesture of appreciation. To facilitate this process, many casinos employ a sophisticated “Rating System” that captures key information about a player based on their gameplay. Factors considered in establishing a player's rating often include their average bet size, the number of hands played, and the duration of their time at the table.

However, the rating process can become tedious and susceptible to inaccuracies when players engage in multiple hands simultaneously or choose to sit out for extended periods. Moreover, as casinos opt to reduce the staff responsible for handling ratings, the process becomes increasingly complex and burdensome for the remaining personnel. For instance, in the past, a casino supervisor would typically oversee the rating of players at four tables. Presently, due to resource optimization, supervisors are commonly assigned the responsibility of managing player ratings at eight or more tables. This approach introduces the potential for errors when determining the number of rounds played by a player and accurately tracking the funds they have brought into play from their own pockets.

### BRIEF DESCRIPTION OF THE DRAWINGS

It is believed that certain embodiments will be better understood from the following description taken in conjunction with the accompanying drawings, in which like references indicate similar elements and in which:

FIG. 1 depicts a block diagram of example hardware that can be used to implement various methods described herein in accordance with one non-limiting embodiment.

FIG. 2 schematically depicts an example table game incorporating various components depicted in FIG. 1.

FIG. 3 schematically depicts an example table game incorporating various hardware components in accordance with one non-limiting embodiment.

FIG. 4 depicts an example bet recognition system in accordance with one non-limiting embodiment.

FIG. 5 depicts another example bet recognition system in accordance with one non-limiting embodiment.

FIG. 6 schematically depicts an example use-case of a utilizing a bet recognition system in accordance with one non-limiting embodiment.

FIG. 7 schematically depicts additional example use-cases using a game signage device to collect various images usable for various casino functions.

### DETAILED DESCRIPTION

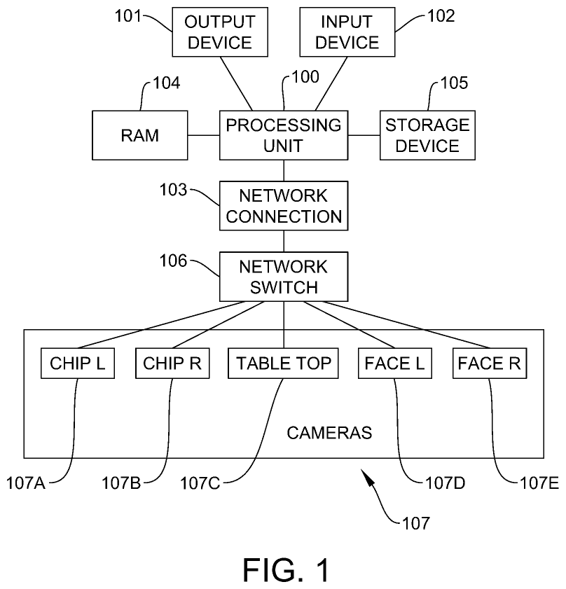

Various non-limiting embodiments of the present disclosure will now be described to provide an overall understanding of the principles of the structure, function, and use of systems, apparatuses, devices, and methods disclosed. One or more examples of these non-limiting embodiments are illustrated in the selected examples disclosed and described in detail with reference made to FIGS. 1-7 in the accompanying drawings. Those of ordinary skill in the art will understand that systems, apparatuses, devices, and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For ease of reading and clarity, certain components, modules, or methods may be described solely in connection with a specific figure. In this disclosure, any identification of specific techniques, arrangements, etc., are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems, and can use other protocols, or operate at other layers in communication protocol stacks, than are described.

Many events occur at a gaming table in a casino environment, often simultaneously. The systems and methods described herein allow for such events to be captured and analyzed using approaches to efficiently manage computing resources. Such approaches, therefore, can require a relatively limited amount of resources, while still providing relevant information to casino operators. In some example embodiments, a system can include one or more cameras positioned proximate to the gaming table and a processor, or multiple processors, to determine events that occur. Image data can be analyzed using machine learning models to understand these events and how to assign tasks to various processes in order to disseminate what had occurred or, in some cases, to determine what is about to occur. In some embodiments, a first machine learning model is maintained at an edge server that can be positioned within a gaming environment, for example. The edge server can be communication with a plurality of different cameras, each positioned at a respective table game or other area of interest. The image data can be processed by the machine learning model for the purposes of object detection. Such object detection can then be operationalized by a casino operator, for example, for a variety of different processes, reporting, and management functions. As described in more detail below, the machine learning model on the edge server can be a copy of machine learning model on a cloud-based server. Through ongoing testing and training activities, the machine learning model on the cloud-based server can be updated for the purposes of improving object detection accuracy. Once the machine learning model has been updated, such updates can be provided to the machine learning model on the edge server. Accordingly, updating the machine learning model on the edge server can happen routinely (i.e., daily, weekly, monthly, etc.), or periodically (i.e., dependent on when updates are available). In any event, this architecture beneficially allows for rapid deployment of an initial machine learning model in an edge server in a gaming environment based on initial training parameters. The version of the machine learning model that is on the cloud-based server can then be tested and trained, such as using training images collected from the gaming environment, to increase the accuracy of the model. Updates to the model on the edge server can be dynamically provided (i.e., via an API) in order to iteratively increase the object detection capabilities of the edge server subsequent to the initial deployment.

Referring first to FIG. 1, a block diagram of example hardware that can be used to implement the methods described herein according to an embodiment is illustrated. A processing unit 100 (such as a microprocessor and any associated components) can be connected to an output device 101. The output device 101 can be any device that conveys information, such as an LCD monitor, a touch screen, a CRT, and so forth. The output device 101 can be used to display any aspect of the processes to a user. The user can be, for example, casino personnel, such as a pit boss, a supervisor, a dealer, a floor manager, and so forth. The system can also include an input device 102 which can be used to input any input from the user. Any suitable form of input device 102 can be used, such as buttons, a touch screen, a keyboard, mouse, and so forth. Processes described herein can be performed by the processing unit 100 by loading and executing respective instructions. While one processing unit 100 is shown for clarity of illustration, multiple such processing units can also work in collaboration with each other, which can be in a same or different physical location. The processing unit 100 can also be in communication with a network connection 103, which can connect the device to a computer communications network such as the Internet, a LAN, WAN, and so forth. The processing unit 100 can communicate with other computers, devices, servers, etc., that are located in a same or different physical location via the network connection 103. The processing unit 100 can also be connected to a RAM 104 and a storage device 105 which can be a disk drive, DVD-drive, CD-ROM drive, flash memory, etc.

One or more cameras 107 can be connected to the processing unit 100 via the network connection 103, or via the network connection 103 and a network switch 106. While one network switch and network connection are shown, it can be appreciated that one or more such connections and/or one or more switches can work together implement the method described herein. Programs and/or data required to implement any of the methods/features described herein can all be stored on any non-transitory computer readable storage medium (volatile or non-volatile, such as CD-ROM, RAM, ROM, EPROM, microprocessor cache, etc.).

The one or more cameras 107 can view an image (still or moving), digitize the image, and transmit the data representing the digitized image to the processing unit 100 (or any other component) so it can be stored and/or analyzed. Cameras in accordance with the present disclosure can be located anywhere on or near a casino table. If a plurality of cameras are utilized, each camera can be pointed in appropriate directions so that they can capture images of what objects are on the table and which players are near the table. While FIG. 1 schematically shows five cameras, namely Chip L camera 107A, Chip R camera 107B, Table Top camera 107C, Face L camera 107D, and Face R camera 107E, it is to be appreciated that other embodiments can utilize different camera arrangements without departing from the scope of the present disclosure. For example, in some embodiments, only a single high-resolution camera 107 is utilized to provide the machine vision-based functionality described herein. Such high-resolution camera 107 can be mounted, for example, at a suitable position proximate to the casino table. In some embodiments, the camera can be a 4K High Definition camera which can optionally include a zoom lens. Moreover, in some embodiments, the high-resolution camera 107 can be a component of, or otherwise associated with, a security surveillance camera system associated with the casino gaming environment.

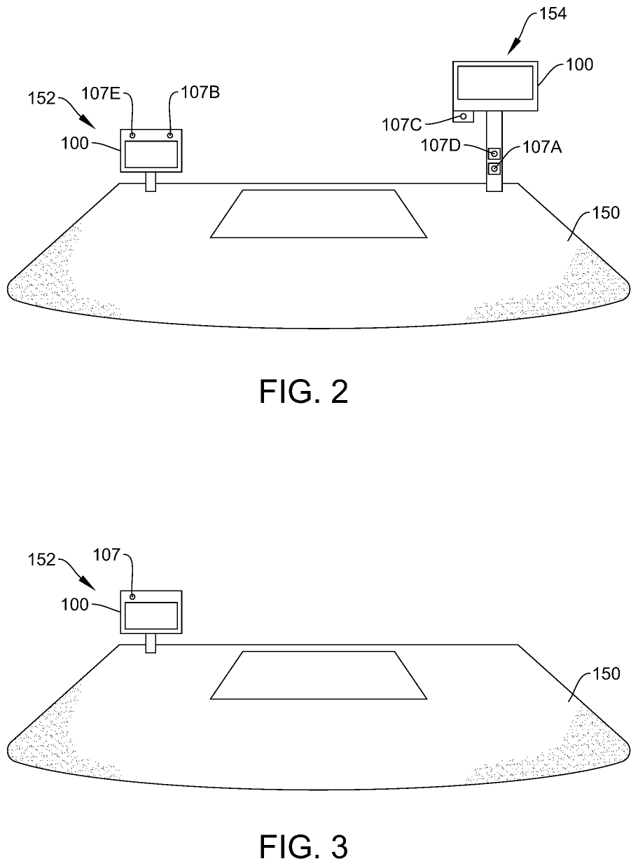

FIG. 2 schematically depicts an example table game 150 incorporating various components depicted in FIG. 1. Table game 150 can be any suitable game in which a player and/or gameplay tracking is desirable, such as, without limitation, blackjack, roulette, craps, three card poker, and baccarat. In the illustrated embodiment, a game signage device 152 is positioned on one side of the table game 150. Additional details regarding examples of game signage device 152 can be found in U.S. Pat. No. 9,524,606, entitled “Method and system for providing dynamic casino game signage with selectable messaging timed to play of a table game,” which is incorporated herein by reference. In the illustrated embodiment, a game signage tower 154 is positioned on another side of the table game 150. Various cameras can be incorporated into the game signage device 152 and the game signage tower 154. Further, the game signage device 152 can house a processing unit 100. Additionally or alternatively, the game signage tower 154 can house a processing unit 100. Furthermore, in some embodiments, a processing unit 100 is positioned remote from the gaming table 150. In other embodiments, a game signage tower 154 is not used, and instead only a game signage device 152 is deployed at the table game 150. In yet other embodiments, one or more cameras are positioned proximate to the table game 150, but not necessarily incorporated into a game signage device 152 or a game signage tower 154, but instead are standalone devices or otherwise incorporated into other components, such as the dealer tray, the table itself, or elsewhere.

Referring to the illustrated non-limiting embodiment, the Face R camera 107E and the Chip R camera 107B are coupled to the game signage device 152. The Table Top camera 107C, the, the Face L camera 107D, and the Chip L camera 107A are coupled to game signage tower 154. As shown, the Table Top camera 107C can be positioned at a higher relative elevation than the Face L camera 107D, and the Chip L camera 107A in order to provide the desired vantage point. It is noted that some or all of the cameras can be generally obscured from view such that players may not be aware of their presence. Further, it is to be appreciated that the arrangement of cameras in FIG. 2 is merely for illustrative purposes. Other embodiments can utilize different camera arrangements without departing from the scope of the current disclosure, including embodiments with fewer cameras or a greater number of cameras. As such, while FIG. 2 illustrates the game signage device 152 incorporate two cameras (107B and 107E), it is to be appreciated that some game signage devices in accordance with the present disclosure may only incorporate a single camera while others may incorporate more than two cameras. All such embodiments are intended to be within the scope of the present disclosure. FIG. 3, for example, illustrates an embodiment with the game signage device 152 incorporating a single high-resolution camera 107 that is positioned at the table game 150.

The systems and methods described herein can utilize computer vision techniques using one or more machine learning models to detect and analyze some or all of the following associated with a gaming table: chips (bet position occupancy and value), cards (presence and value), other objects in the field of view. Based on the recognition of chips, cards, and/or other objects, such information can be operationalized by the casino for automated player rating process, AML monitoring, game protection purposes, work force management, among a variety of other uses. Such technology can also beneficially increase the accuracy of various trackable events while reducing the amount of time needed from casino staff. By way of one example, once a player is at a table, they would place their chips in a betting area to play. It is also not uncommon for people to move from one betting area to another or to play more than one bet position. In addition to this, people may choose to wait out a hand or more than one. The staff is directed to watch the players as often as they can to determine who is playing where, how much they are betting, how many hands they played, when they leave, amongst other things. In some situations, the staff may be required to watch for such things at upwards of eight tables at one time. Thus, determining what time someone sat down and first started playing and when the player left is difficult when potentially watching 50 people at any given time.

Thus, embodiments of the present disclosure aid in determining if a bet position is active and, if so, the exact amount of bets that were placed at that betting position based on the bet recognition process described herein. Such recognized bets can then the attributed to the player playing at the bet position based on player loyalty identification information provided to dealer, for example. The bets recognized using the machine learning models described herein can be used to determine amount played, hand win/loss, and time of the round. The process for detecting positions played and how often they are played can provide more exact information for the casino for complimentary offerings and for understanding the utilization of their games for a variety of operational purposes.

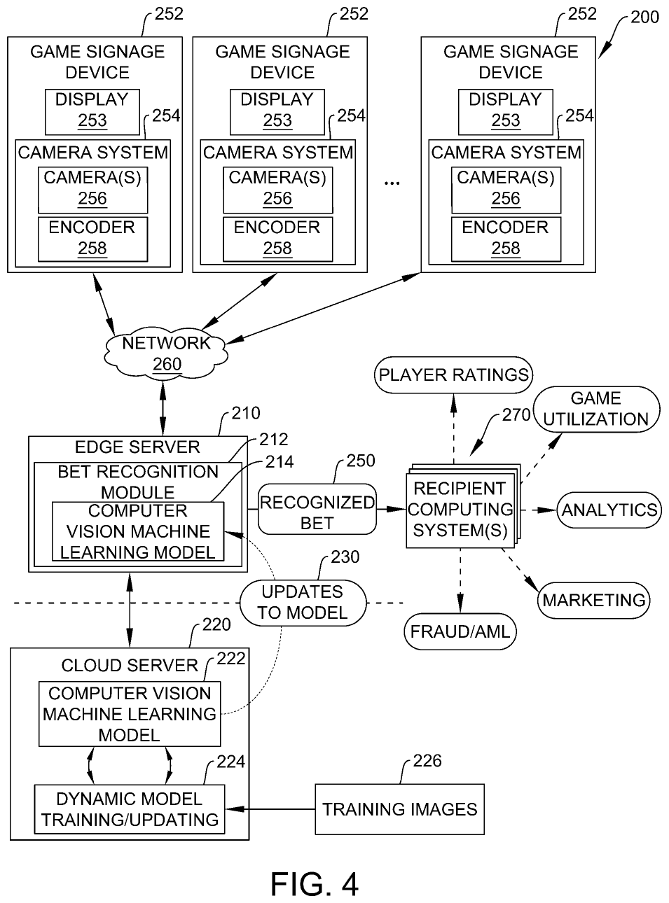

Referring now to FIG. 4, an example bet recognition system 200 in accordance with one non-limiting embodiment is depicted. The bet recognition system 200 can include a plurality of game signage devices 252 that are each positioned proximate to a respective table game (not shown). The game signage devices 252 can house a variety of components, such as a display 253 and a camera system 254. In some embodiments, the game signage devices 252 include a plurality of displays 253, such that one display is a customer-facing side for providing custom content, sports scores, rules and limits, advertisements, and so forth. A staff-facing display can be, for example, a touchscreen that allows casino staff to interact with the device. In some embodiments, game signage devices 252 further include an embedded card swipe, or other input means, for receiving player identification data for player ratings purposes.

The camera system 254 can include at least one high-definition camera 256 and an encoder 258. The encoder 258 can compress and convert the raw visual data captured by the high-definition camera 254 into a format that is more efficient for storage or transmission. The encoder 258 can employ any suitable encoding protocol, such as H.264, H.265, VP9, MPEG-2, MPEG-4 Part 2, among others, to compress video data collected by the camera 256 so that it can be provided to an edge server 210 via a communications network 260. The communications network 260 can utilize wired or wireless connections, including but not limited to Ethernet, Wi-Fi, cellular networks, or a combination thereof. As is to be appreciated, relevant security measures can be employed by the communications network 260, such as encryption protocols, firewalls, or authentication mechanisms.

As is known in the art, an edge server 210 is a type of server that is located closer to the end users or devices it serves, typically at the edge of a network or closer to the network's access points. Here, the edge server 210 can be placed within the gaming environment and in relatively close proximity to the plurality of game signage devices 252 to aid in optimizing content delivery and reducing latency. In some embodiments, the edge service 210 can be configured to receive camera feeds from 60 gaming tables or more. The edge server 219 can perform tasks such as processing data, running applications, and executing specific functions at the network edge. In accordance with the present disclosure, the edge server 210 can include a bet recognition module 212 that is used to identify that amount of bets placed at a table game based on the encoded video feed captures by the camera 256. More specifically, images of the chips placed on the table game by a player can be analyzed, via a computer vision machine learning model 214 stored locally by the edge server 219, to assess the value and quantity of chips being played in each bet position at the gaming table. In some example embodiments, the computer vision machine learning model 214 can be initially trained on a large dataset of images with labeled objects. During the training process, the model can learn patterns and features that distinguish different objects in the images. It tries to find relationships between pixel values, shapes, textures, and other visual characteristics that are indicative of specific objects. The bet recognition module 212 can use any suitable object detection algorithms and architectures, such as Faster R-CNN, YOLO (You Only Look Once), and SSD (Single Shot MultiBox Detector), for example.

As schematically shown in FIG. 4, the recognized bet 250 can be provided to various recipient computing systems 270 so the bet information can be operationalized. Without limitation, the recognized bet 250 can be usable for player ratings, game utilization analytics, marketing purposes, fraud/AML tracking, as well as a wide variety of other types of analytics and processes. With regard to player ratings, the recognized bet 250 can be used to determine the average daily theoretical loss of a player for example. The average daily theoretical loss is a valuable metric for casinos as it helps them assess a player's value and determine appropriate comps, such as free meals, hotel rooms, or other rewards. Additionally, it aids in managing the casino's overall profitability and making informed marketing and player development decisions. The average amount a player wagers per bet is an essential factor in calculating the theoretical loss. As such, the systems and methods described herein for accurately and automatically determining the amount of each bet for each player at a gamine table is particularly beneficial.

In some example embodiments, the computer vision machine learning model 214 is not necessarily trained with images from the actual use-case environment or other synthetic training data generated from the actual use-case environment. Instead, the computer vision machine learning model 214 can be initially deployed based on generic training data (i.e., using images of casino chips, but not necessarily images of the actual chips used by players within the particular gaming environment). In accordance with the present disclosure, a cloud server 220 associated with the gaming environment can also store a version of the computer vision machine learning model 222. The cloud server 220 does not necessarily need to physically be on-site and can be deployed as a virtual infrastructure. The version of the computer vision machine learning model 222 stored by the cloud server 220 can initially be the same version as is deployed on the edge server 210. The computer vision machine learning model 222, however, can be trained using a plurality of training images 226 and/or other synthetic training data using various training techniques. Such training can utilize, for example, actual images of the chips from the gaming environment. In some embodiments, a user interface of the cloud server 220 allows for the review and validation of the object detection such the overall accuracy can be improved. Through the testing and training performed at the cloud server 220, the computer vision machine learning model 222 can be updated and improved over time. Subsequently, such updates 230 can be pushed to the edge server 210 (i.e., via an API) such that the computer vision machine learning model 214 receives the benefit of the improved model thereby allowing it to be dynamically and iteratively updated. Such updates 230 can be provided to the edge server 210 routinely, such as on a particular schedule (i.e., daily, weekly, etc.), or otherwise provided whenever updates are available. Such approach to deploying an initial model on-premises and then iteratively improving the model in a cloud-based environment, can beneficially allow for an initial deployment and then a rapid increase in the accuracy of object detection regardless of table layout, chip design, etc.

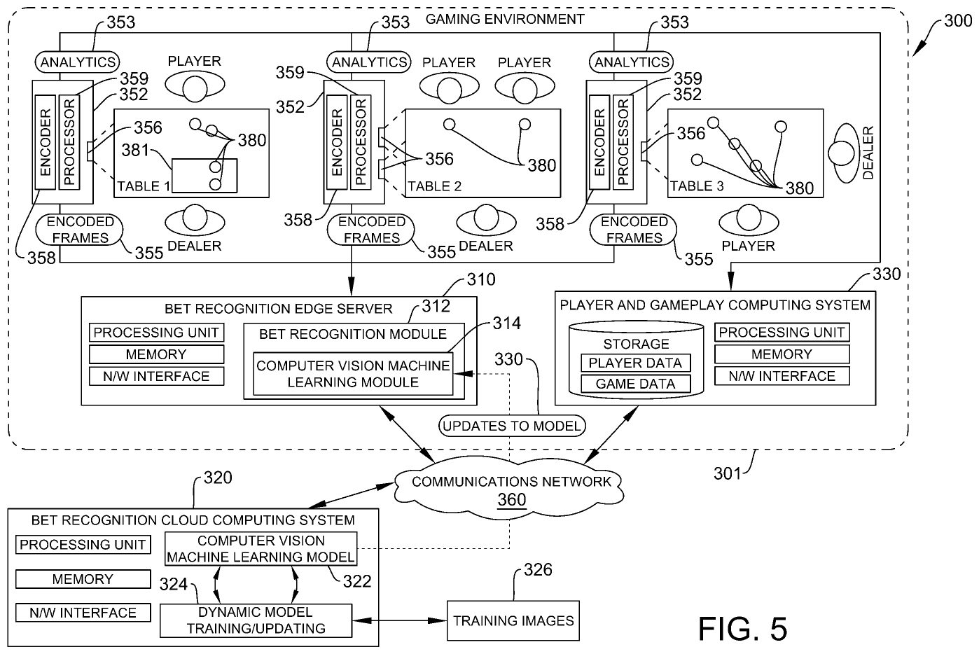

FIG. 5 depicts another example bet recognition system 300 in accordance with one non-limiting embodiment. In the illustrated embodiment a plurality of table games (shown as Tables 1-3) are positioned within a gaming environment 301, such as a brick-and-mortar casino. A camera 356, processor 359, and encoder 358 are associated with each table game. As described above, in some embodiments the components can be part of a game signage device installed at the table game, although this disclosure is not so limited. The camera 356 can have a field of view that captures gameplay on the table game and in particular captures gaming objects 380 for object recognition. Gaming objects 380 can be any of a variety of objects that can be trackable in accordance with the present disclosure, such as gaming chips, playing cards, dice, currency, among other objects. In some embodiments, gaming objects 380 can be tracked and accounted for when they are present in a particular define area on the table gaming table, such as proximate to a betting circle, within a dealer's chip tray, placed on a gameboard, and so forth. An example chip tray 381 is schematically shown on Table 1 in FIG. 5. With regard to gaming objects, such as casino chips, within a dealer's chip tray, in some embodiments systems and methods described herein can be used to provide various types of monitoring or tracking, such as tracking the float of the chip tray throughout a gameplay session. Furthermore, in some embodiments tracking the outcome of each deal/game, the float of the chip tray can be compared against an expected value based on the outcome of each deal, the bet size of each player, and the result of each player's bet, for example.

As schematically shown, in accordance with various embodiments, analytics 353 can be provided to a player and gameplay computing system 330. Such analytics 353 can include, for example, player identification data, hands-per-hours, and other analytics that do not necessarily need object detection to extract the data. Encoded frames 355, generated by the encoders 358 and based on the images collected by the cameras 356, can be transmitted to a bet recognition edge server 310. As shown, the edge server 310 the be positioned on-premises, although this disclosure is not so limited. Further, as is to be appreciated, the edge server 310 can include various components, such as a processing unit (i.e., a high-performance CPU or GPU), memory, and a network interface. The edge server 310 can also include a bet recognition module 312 that utilizes a local computer vision machine learning model 314 for object detection.

Similar to the cloud server 220 described above, the bet recognition system 300 can include a bet recognition cloud computing system 320 that also includes a processing unit, memory, a network interface, amount other components. The bet recognition cloud computing system 320 can further include a computer vision machine learning model 322. At initial deployment, the computer vision machine learning model 314 can be a copy of the computer vision machine learning model 322. The computer vision machine learning model 322, however, can be updated during training processes 324 that occur over time, which can be based on training images 326, among other inputs. The training process 324 are designed to increase the accuracy of the object detection, as related to bet recognition or other gaming objects 380 being tracked. Updates 330 to the computer vision machine learning model 314 can be provided to the bet recognition edge server 310 by the bet recognition cloud computing system 320 via network communications via a communications network 360. Additionally, bet recognition, as performed by the bet recognition edge server 310, can be provided to the player and gameplay computing system 330 for inclusion with player data, game data, or other data sets.

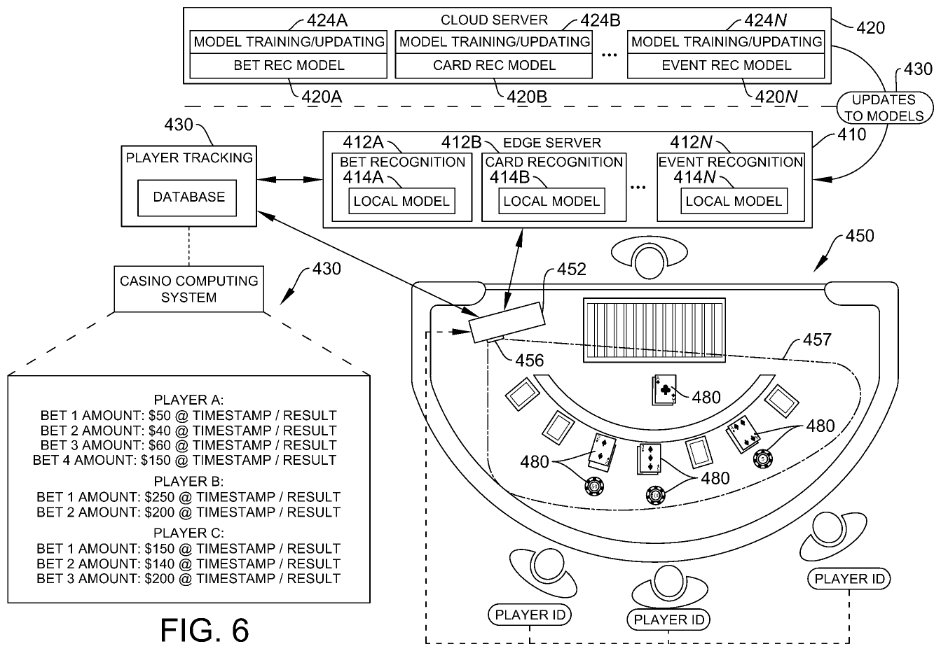

Referring now to FIG. 6, an example use-case of a utilizing a bet recognition system in accordance with one non-limiting embodiment is depicted. A game signage device 452 comprising a camera 456 is positioned to capture images of gaming objects 480 positioned on the surface of a gaming table 450. In the illustrated example, the field of view 457 is sufficient to capture all the relevant gaming objects 480. It is appreciated, however, that other embodiments can utilize a plurality of cameras 456 with different fields of view, or even overlapping fields of views. Player identifiers associated with the players that are placing bets at the gaming table 350 can be provided to the game signage device 452 using any of a variety of data input techniques. In one embodiment, players cards are swiped using a card reader, while other embodiments can utilize an optical reader to scan an QR code, a bar code, or other optically readable indicator. In some embodiments, as described below, the camera 456 can be leveraged to capture the player identifiers. In any event, the player identifiers can be received and associated with a particular betting position as the gaming table 450 by a player tracking process 430.

The game signage device 452 can encode the video stream capture by the camera 456 and provide the compressed stream to an edge server 410 for processing. In the illustrated embodiment, the edge server 410 includes a plurality of different modules that are each tuned to provide a particular type of object detection based on a particular model locally stored by the server. For example, bet recognition module 412A can use model 414A to determine the value of each bet placed at each betting position. Card recognition module 412b can use model 414B to determine the value of cards dealt during gameplay. Other events can be detected by additional modules (shown as module 412N) leveraging various models (shown as model 414N). Furthermore, while bet recognition and card recognition are illustrated as two separate modules leverage two separate models, it is to be appreciated that the same module can be trained to perform both types of recognition. During gameplay, based on the output of the bet recognition and card recognition modules, various game-related data can be tracked, logged, and analyzed. As schematically shown by gameplay data 430, each player's betting amounts can be timestamped and associated with a particular hand and outcome. Such information can be used for a variety of purposes, including AML analytics, fraud detection, among others.

Similar to the embodiments described above, copies of the machine learning models used by the edge server 410 can also be stored on a cloud server 420, illustrated as models 420A-N. These machine learning models 420A-N can beneficially be continually trained and updated during training process 424A-N. Updates 430 to the models hosted by the edge server 410 can be periodically provided, thereby allowing the accuracy of the object detection being provided by the edge server 410 to be iteratively improved over time.

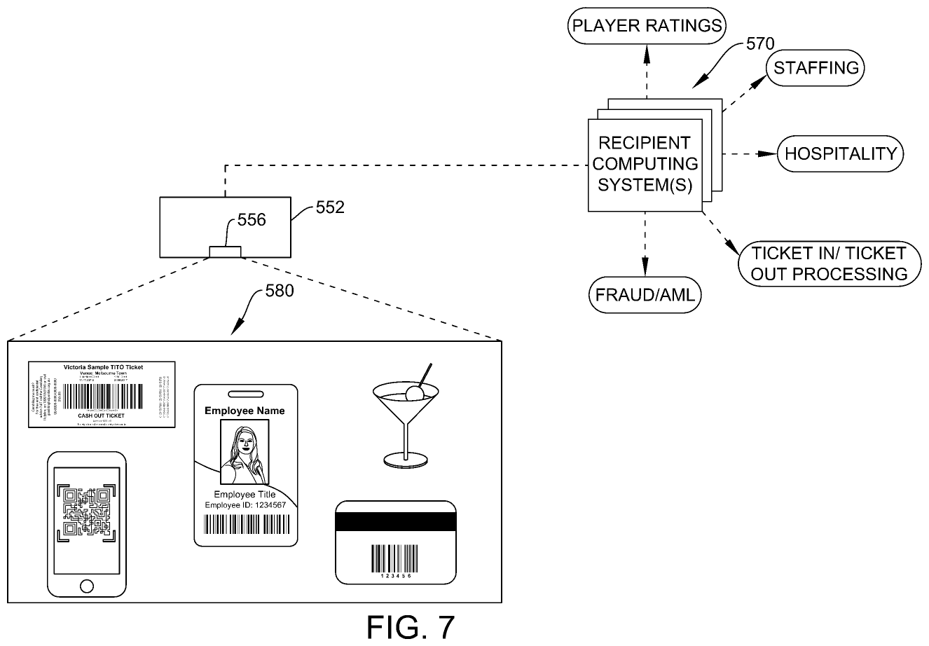

FIG. 7 schematically depicts additional example use-cases using a game signage 552 device to collect various images with a camera 556 that are usable for various casino functions. Non limited examples of collectable images 580 are shown in FIG. 7. By way of example, collectable images 580 can include, but are not limited to, ticket-in/ticket-out (TITO) tickets, employee badges, player identifiers (QR codes, bar codes, etc.). In some embodiments, the camera 556 can also be leveraged to collect hospitality-related information (i.e., detect the level of a player's drink). Processing of the collectable images 580 can be used in a variety of casino-related functions 570, such as player ratings, staffing/workforce functions, hospitality functions, TITO processing, fraud/AML tracking, and so forth.

Any element expressed herein as a means for performing a specified function is intended to encompass any way of performing that function, including a combination of elements that perform that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

Moreover, the processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A non-transitory computer-readable medium may also include memory storage that may be physical, virtual, permanent, temporary, semi-permanent and/or semi-temporary.

A “computer,” “computer system,” “host,” “engine,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as tracking demand for processing power from different machines, prioritizing and scheduling tasks based on network demand, and/or providing backup contingency in the event of component failure or reduction in operability.

The examples presented herein are intended to illustrate potential and specific implementations. It can be appreciated that the examples are intended primarily for purposes of illustration of the invention for those skilled in the art. No particular aspect or aspects of the examples are necessarily intended to limit the scope of the present disclosure. No particular aspect or aspects of the examples of system architectures, table layouts, or report formats described herein are necessarily intended to limit the scope of the disclosure.

In general, it will be apparent to one of ordinary skill in the art that various embodiments described herein, or components or parts thereof, may be implemented in many different embodiments of software, firmware, hardware, or modules thereof. The software code or specialized control hardware used to implement some of the present embodiments is not limiting of the present invention. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present disclosure based on the description herein with only a reasonable effort and without undue experimentation.

In various embodiments, the systems and methods described herein may be configured and/or programmed to include one or more of the above-described electronic, computer-based elements, and components. In addition, these elements and components may be particularly configured to execute the various rules, algorithms, programs, processes, and method steps described herein.

While various embodiments have been described herein, it should be apparent that various modifications, alterations and adaptations to those embodiments may occur to persons skilled in the art with the attainment of some or all of the advantages of the present disclosure. The disclosed embodiments are therefore intended to include all such modifications, alterations, and adaptations without departing from the scope and spirit of the present disclosure as set forth in the appended claims.

1. A gameplay tracking system, comprising:
a first camera system positioned proximate to a table game and configured to generate a first image feed;
a second camera system positioned proximate to the table game and configured to generate a first image feed;
an edge server in communication with the first and second camera systems, wherein the edge service received the first and second image feeds, wherein a local machine learning model executed on the edge server performs object detection on the first and second image feeds to generate an output; and
a cloud server in communication with the edge server, wherein the cloud server comprises a machine learning model, wherein the machine learning model of the cloud server is trained to increase accuracy and updated, wherein the updated machine learning model is provided to the edge server.

2. The system of claim 1, further comprises a game signage device positioned at that table came, wherein at least one of the first camera system and the second camera system is incorporated into the game signage device.

3. The system of claim 1, wherein object detection identifies any of a gaming chip, a playing card, currency, and a die.

4. The system of claim 1, wherein the table game and the edge server are positioned within a gaming environment.

5. The system of claim 4, wherein the cloud server is positioned outside the gaming environment.

6. The system of claim 1, wherein the local machine learning model identifies an amount of a bet placed at the table game based on a value and quantity of chips placed in a bet position.

7. The system of claim 6, wherein the amount of the bet is used for any of player ratings, game utilization analytics, marketing purposes, and AML purposes.

8. The system of claim 1, wherein the local machine learning model of the edge server and the machine learning model of the cloud server are initially deployed based on generic training data, wherein the accuracy of the machine learning model of the cloud server is subsequently increased based on additional training to generate an updated machine learning model, and wherein the local machine learning model is replaced with the updated machine learning model.

9. The system of claim 1, wherein at least one of the first camera system and the second camera system are a component of a gaming environment security surveillance camera system.

10. A computer-based method of gameplay tracking at a table game in a gaming environment, the method comprising:
provisioning a machine learning model on each of an edge server and a cloud server:
receiving, by the edge server, a first image feed from a first camera system, wherein the first camera system is positioned proximate to a table game in a gaming environment;
detecting, by the machine learning model executing on the edge server, an object in the first image feed;
providing training data to the machine learning model on the cloud server to update the machine learning model on the cloud server; and
subsequent to updating the machine learning model on the cloud server, providing the updates to the machine learning model on the edge server.

11. The method of claim 10, wherein the table game and the edge server are positioned within a gaming environment.

12. The method of claim 11, wherein the cloud server is positioned outside the gaming environment.

13. The method of claim 10, wherein provisioning the machine learning model on each of the edge server and the cloud server comprises provisioning a machine learning model on each of the edge server and the cloud server are initially trained on generic training data.

14. The method of claim 13, wherein providing training data to the machine learning model on the cloud server to update the machine learning model on the cloud server comprises providing images of actual chips from the gaming environment as training data.

15. The method of claim 10, wherein the machine learning model on the edge server identifies an amount of a bet placed at the table game based on a value and quantity of chips placed in a bet position.

16. The method of claim 15, wherein the amount of the bet is used for any of player ratings, game utilization analytics, marketing purposes, and AML purposes.

17. A gameplay tracking system, comprising:
a camera system positioned proximate to a table game in a gaming environment, wherein the camera system is configured to generate an image feed;
an edge server positioned within the gaming environment and in communication with the camera system, wherein the edge server is configured to process the image feed using a machine learning model stored on the edge server; and
a cloud server positioned external to the gaming environment, wherein the cloud server comprises a copy of the machine learning model, wherein the machine learning model of the cloud server is trained to increase accuracy and updated, wherein the updated machine learning model is provided to the edge server.

18. The system of claim 17, wherein the machine learning model on the edge server is configured to identify an amount of a bet placed at the table game based on a value and quantity of chips placed in a bet position.

19. The system of claim 18, wherein the amount of the bet is used for any of player ratings, game utilization analytics, marketing purposes, and AML purposes.

20. The system of claim 17, wherein the edge server are positioned within the gaming environment and the cloud server is positioned outside the gaming environment.
